(19) United States
(12) Patent Application Publication
(10) Pub. No.: US 2023/0345549 A1
(43) Pub. Date: Oct. 26, 2023

(54) WAVEFORM SUPPORT CAPABILITY SIGNALING DURING INITIAL ACCESS

(71) Applicant: QUALCOMM Incorporated, San Diego, CA (US)

(72) Inventors: Ahmed ELSHAFIE, San Diego, CA (US); Hung Dinh LY, San Diego, CA (US); Krishna Kiran MUKKAVILLI, San Diego, CA (US)

(21) Appl. No.: 17/660,368

(22) Filed: Apr. 22, 2022

(51) Int. Cl. H04W 74/08; H04W 72/04; H04L 27/26

(52) U.S. Cl. CPC H04W 74/0841; H04W 74/0866; H04W 72/0446; H04L 27/2607

(57) ABSTRACT

Certain aspects of the present disclosure provide techniques for wireless communications by a user equipment (UE). The UE transmits, to a network entity, via one or more random access channel (RACH) messages, information indicating one or more downlink waveforms supported by the UE. The UE receives, from the network entity, one or more downlink transmissions using the one or more downlink waveforms supported by the UE.

### BACKGROUND

### Field of the Disclosure

Aspects of the present disclosure relate to wireless communications, and more particularly, to techniques for signaling downlink waveform support capability during an initial access procedure.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment (UE). The method includes transmitting, to a network entity, via one or more random access channel (RACH) messages, information indicating one or more downlink waveforms supported by the UE; and receiving, from the network entity, one or more downlink transmissions using the one or more downlink waveforms supported by the UE.

Another aspect provides a method of wireless communications by a network entity. The method includes receiving, from a UE, via one or more RACH messages, information indicating one or more downlink waveforms supported by the UE; and transmitting, to the UE, one or more downlink transmissions using the one or more downlink waveforms supported by the UE.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts example 5^{th} generation (5G) new radio (NR) waveforms.

FIG. 6 depicts example single carrier (SC) waveform.

FIG. 7A depicts four-step random access channel (RACH) procedure.

FIG. 7B depicts RACH messages exchanged between a UE and a network entity during the four-step RACH procedure.

FIG. 8A depicts two-step RACH procedure.

FIG. 8B depicts RACH messages exchanged between a UE and a network entity during the two-step RACH procedure.

FIGS. 9A-9C depict example process flows for communications in a network between a UE and a network entity.

FIG. 10 depicts a method for wireless communications by a UE.

FIG. 11 depicts a method for wireless communications by a network entity.

FIG. 12 depicts aspects of an example communications device.

FIG. 13 depicts aspects of an example communications device.

### DETAILED DESCRIPTION

When a user equipment (UE) initially accesses a network entity, a random access procedure (RACH) is performed. The RACH procedure is a multi-step procedure, and may be performed using one of multiple waveforms (e.g., a discrete fourier transform-spread-orthogonal frequency division multiplexing (DFT-S-OFDM) waveform, a cyclic prefix orthogonal frequency division multiplexing (CP-OFDM) waveform, and/or other waveforms).

Some UEs may only support the CP-OFDM waveform, by default. Since the RACH procedure can be performed using different waveforms and some UEs only support the CP-OFDM waveform by default, there is a need for the UE to signal (e.g., via UE capability information) whether a single carrier (SC) waveform (e.g., DFT-S-OFDM waveform) is also supported by the UE.

Aspects of the present disclosure provide mechanisms for signaling a UE capability to support multiple waveforms. For example, in some cases, a UE may indicate: (i) support for a SC waveform in a downlink (i.e., whether a UE has a transceiver for a DFT-S-OFDM waveform during an initial access procedure), (ii) a switching time between two waveforms (e.g., the DFT-S-OFDM waveform and a CP-OFDM waveform) during the initial access procedure, and/or (iii) a preference in using a certain waveform (e.g., the DFT-S-OFDM waveform or the CP-OFDM waveform) during the initial access procedure.

In some cases, signaling the UE capability to support multiple different waveforms (e.g., via a physical RACH (PRACH) preamble, a mask, and/or other techniques) may result in a higher data rate and spectral efficiency. For example, in some scenarios that may require a high energy efficiency, the UE capability may indicate support and preference of the DFT-S-OFDM waveform (e.g., suitable for a power efficient transmission and having a low peak-to-average-power ratio (PAPR)) over the CP-OFDM waveform. The lower PAPR of the DFT-S-OFDM waveform translates to a higher power added (PA) efficiency and data rate.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

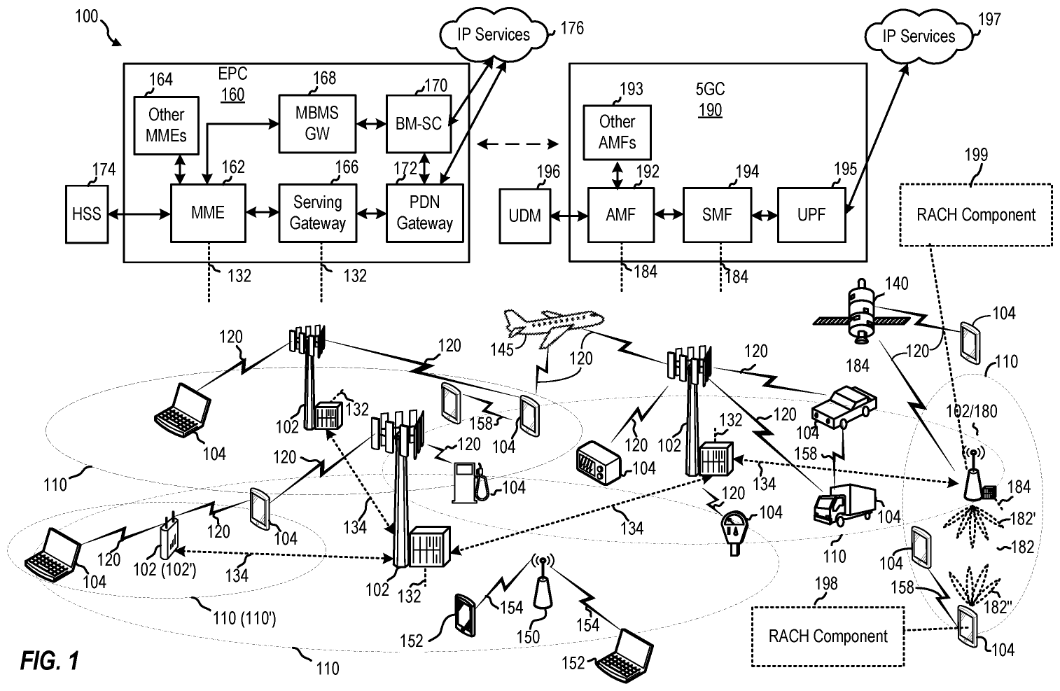

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

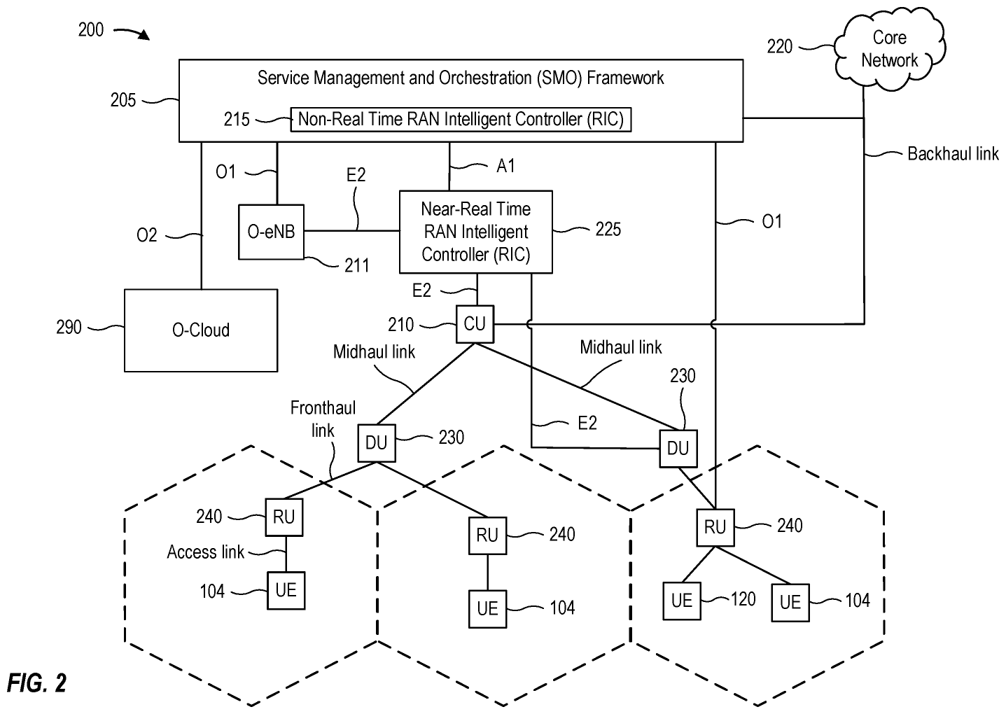

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

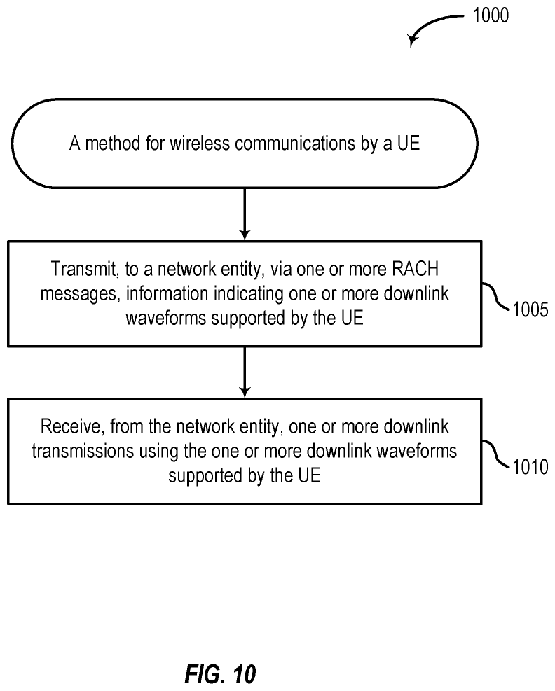

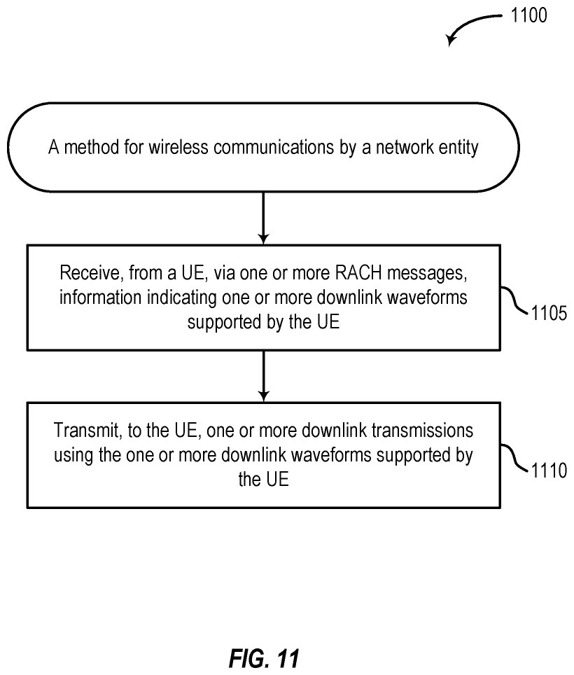

Wireless communication network 100 further includes random access channel (RACH) component 198, which may be configured to perform method 1000 of FIG. 10. Wireless communication network 100 further includes RACH component 199, which may be configured to perform method 1100 of FIG. 11.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (MC) 225 via an E2 link, or a Non-Real Time (Non-RT) MC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT MC 225, the Non-RT RIC 215 may receive parameters or external enrichment information from external servers. Such information may be utilized by the Near-RT MC 225 and may be received at the SMO Framework 205 or the Non-RT MC 215 from non-network data sources or from network functions. In some examples, the Non-RT MC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

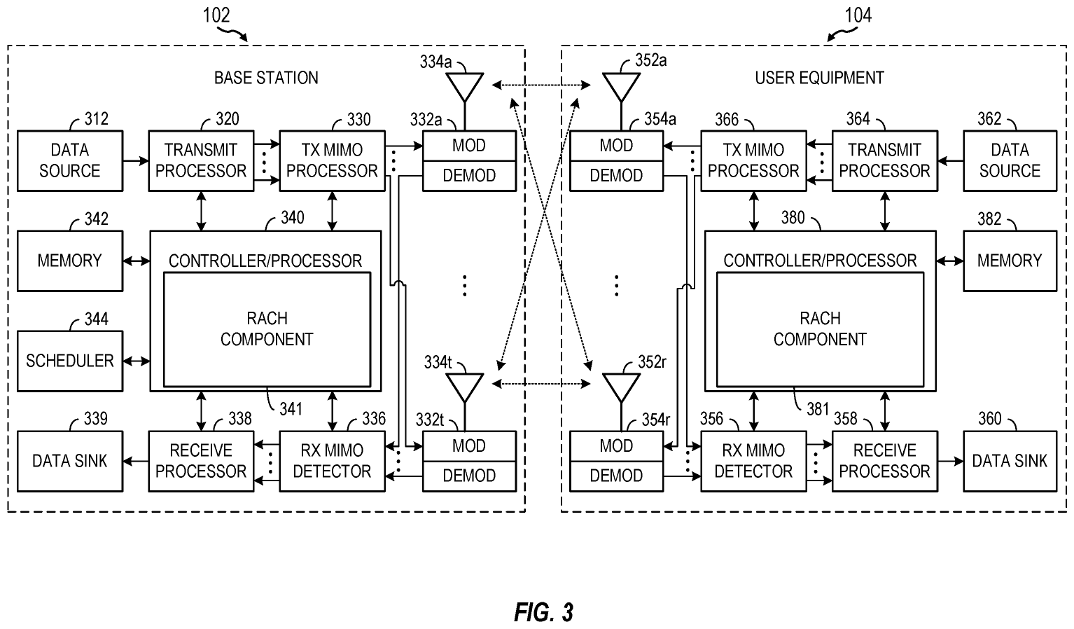

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes RACH component 341, which may be representative of RACH component 199 of FIG. 1. Notably, while depicted as an aspect of controller/processor 340, RACH component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes RACH component 381, which may be representative of RACH component 198 of FIG. 1. Notably, while depicted as an aspect of controller/processor 380, RACH component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

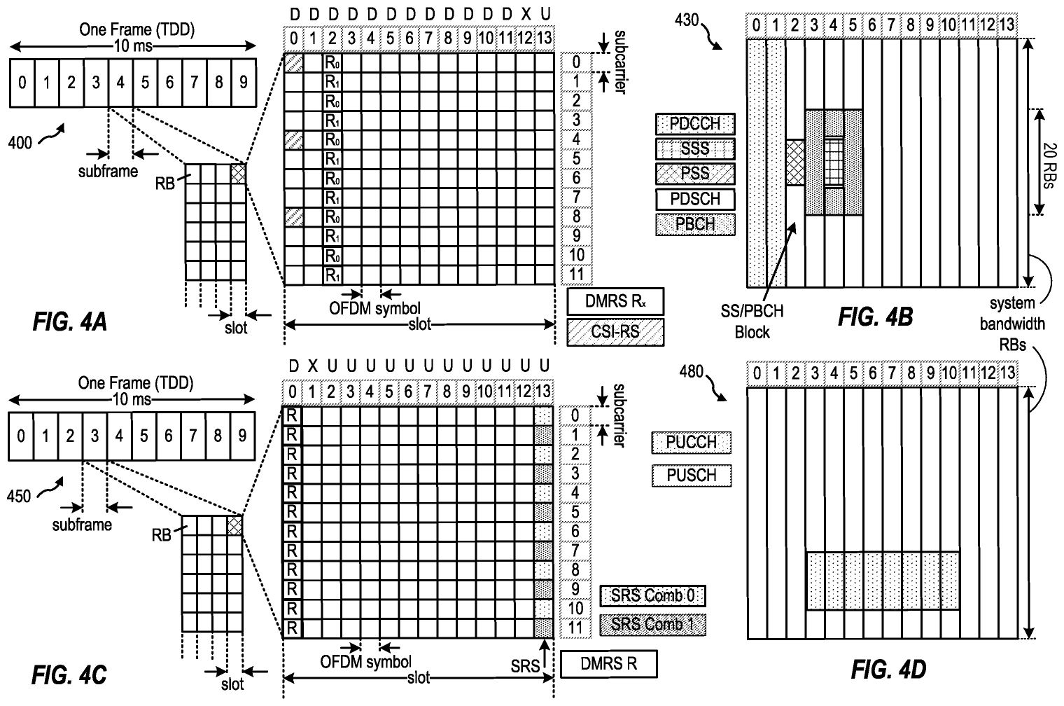

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example 5^{th} Generation (5G) New Radio (NR) Waveforms

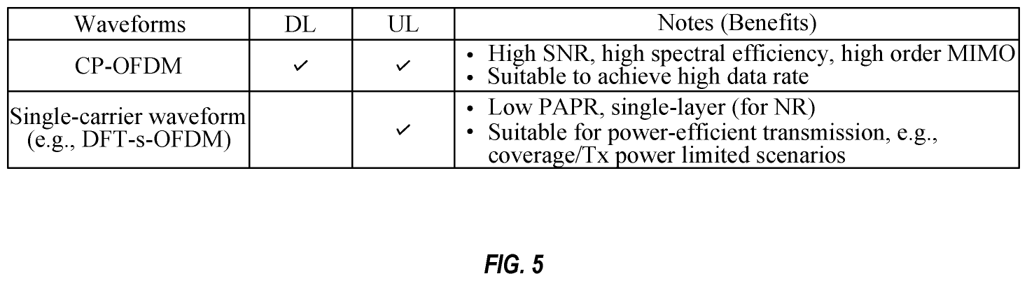

To improve throughput and increase an amount of data being transferred, a user equipment (UE) is equipped to operate using various waveforms (as illustrated in FIG. 5), for example, a discrete fourier transform-spread-orthogonal frequency division multiplexing (DFT-S-OFDM) waveform, a cyclic prefix orthogonal frequency division multiplexing (CP-OFDM) waveform, and/or other waveforms.

The CP-OFDM waveform is used for a single-stream transmission and/or multi-stream (e.g., multiple input multiple output (MIMO)) transmissions. The CP-OFDM waveform is supported for higher bands (e.g., FR4 and beyond). The CP-OFDM waveform is backward compatible with FR1/FR2/FR2x waveform. The CP-OFDM waveform provides a high signal to noise ratio (SNR) and a high order MIMO. The CP-OFDM waveform is also suitable to achieve a high data rate. In some scenarios (e.g., where energy efficiency requirement is more relaxed), the CP-OFDM waveform offers a high spectral efficiency.

The DFT-S-OFDM waveform is a single carrier (SC) waveform, and is therefore limited to single stream transmissions (e.g., link budget limited cases). The DFT-S-OFDM waveform provides a low peak-to-average-power ratio (PAPR). The DFT-S-OFDM waveform is suitable for a power-efficient transmission, e.g., coverage/transmit power limited scenarios.

The DFT-S-OFDM waveform is supported for scenarios requiring a high energy efficiency. For example, the lower PAPR translates to a higher power added (PA) efficiency. The high data rate can also be achieved due to a massive spectrum availability. In some cases, to facilitate frequency domain equalization, a cyclic prefix (CP) is introduced to create OFDM-like blocks or symbols. Also, a guard interval (GI), which is a known sequence, can be considered as a special case of the CP in this context.

The DFT-S-OFDM waveform (e.g., in a frequency-domain implementation) has a relatively high complexity, based on a frequency-domain transform precoding at a transmitter and a frequency-domain equalization at a receiver. The DFT-S-OFDM waveform has more efficient bandwidth utilization than SC quadrature amplitude modulation (SC-QAM). The DFT-S-OFDM waveform provides more flexible bandwidth allocation, and thus easy to support large bandwidth.

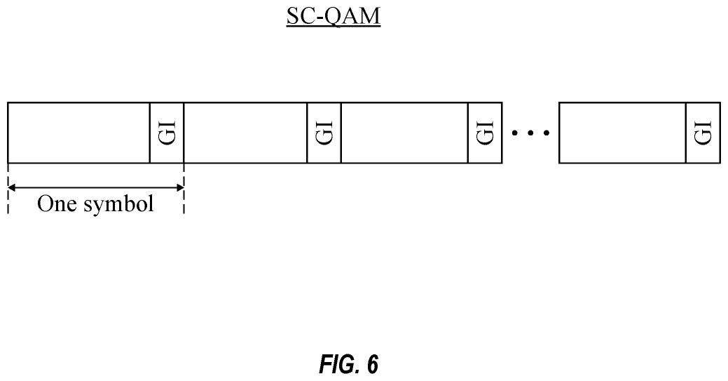

The SC-QAM (e.g., in a time-domain implementation) has a low complexity, based on a time-domain filtering (e.g., pulse shaping filters at a transmitter, and matched filtering/time-domain equalization at a receiver). The DFT-S-OFDM waveform has more bandwidth growth (e.g., by time-domain filtering) and needs a guard band (e.g., as illustrated in FIG. 6). The DFT-S-OFDM waveform provides a restricted bandwidth allocation, and thus there is an increase in the complexity to support diverse bandwidth allocation.

### Example Random Access Channel (RACH) Procedures

To connect a user equipment (UE) to a 5^{th} generation (5G) network, the UE has to synchronize in downlink as well as in uplink. Downlink synchronization is obtained after successfully decoding synchronization signal block (SSB). In order to establish uplink synchronization and radio resource control (RRC) connection, the UE performs a random access channel (RACH) procedure.

The RACH procedure may be performed in certain scenarios, including: during a transition from idle mode to connected mode, intrasystem handovers, RRC connection re-establishment, and/or when uplink/downlink data arrives when the UE is in an asynchronous state.

The RACH procedure may be a contention based or non-contention based. The contention based RACH procedure involves the UE selecting a physical RACH (PRACH) resource. The non-contention based RACH procedure involves narrowband (NB) allocating resources to the UE.

The RACH procedure may be a multi-step procedure or have multiple stages. For example, the RACH procedure may be a four-step RACH procedure or a two-step RACH procedure.

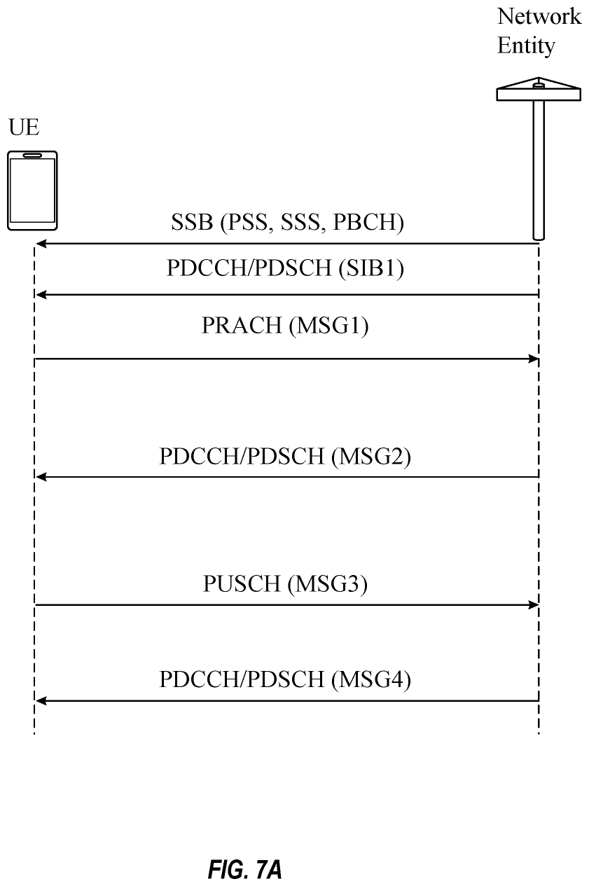

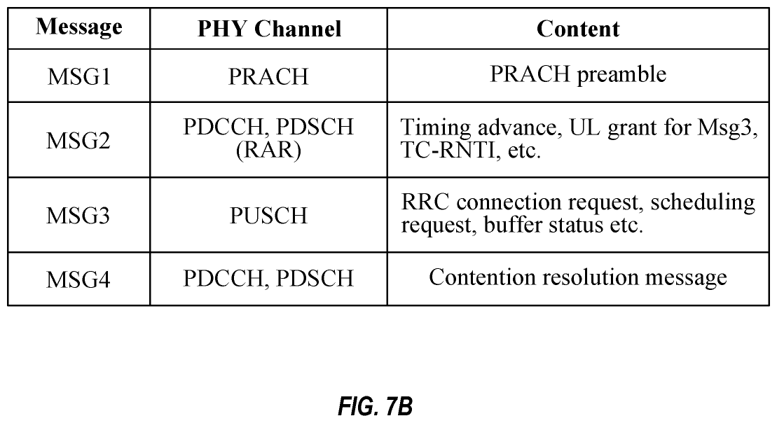

FIGS. 7A and 7B illustrate an example four-step RACH procedure at a UE. Initially, a network entity sends an SSB to the UE for downlink synchronization. The SSB includes a primary synchronization signal (PSS), a secondary synchronization signal (SSS) and a physical broadcast channel (PBCH). The network entity also sends a system information block #1 (SIB1) to the UE. The SIB1 carries information relevant when evaluating if the UE is allowed to access a cell and defines the scheduling of other system information.

To establish uplink synchronization, the UE performs the four-step RACH procedure. For example, the UE transmits a message 1 (e.g., MSG1) to the network entity. The UE transmits the message 1 using a preamble (also referred to as a RACH preamble, a PRACH preamble, etc.) that is selected from different RACH preambles. The UE also transmits identity of the UE to the network entity so that the network entity can address the UE in a next operation. The identity used by the UE may be a random access-radio network temporary identifier (RA-RNTI), which is determined from a time slot number in which the RACH preamble or sequence is sent.

The UE receives a message 2 (e.g., MSG2) from the network entity (e.g., over a physical downlink shared channel (PDSCH)). The UE receives the message 2, in response to sending the message 1 to the network entity. The message 2 may be a random access response (RAR) and received on a downlink-shared channel (DL-SCH) from the network entity. The RAR may be addressed to the RA-RNTI calculated by the network entity from the timeslot in which the preamble or sequence is sent. The message 2 may also carry following information: a cell-radio network temporary identifier (C-RNTI) which may be used for further communications between UE and the network entity; a timing advance value which informs UE to change timing of the UE to compensate for round trip delay due to the distance between the UE and the network entity; and/or uplink grant resources which may be initial resources assigned to the UE by the network entity so that the UE can use a uplink-shared channel (UL-SCH) during operation.

The UE transmits a message 3 (e.g., MSG3) to the network entity (e.g., over a physical uplink shared channel (PUSCH)). The UE transmits the message 3, which may be an “RRC connection request message,” to the network entity, in response to receiving the message 2 from the network entity. The RRC connection request message is sent to the network entity using the UL-SCH based on uplink grant resources granted during the previous operation. The UE may use the C-RNTI that is assigned to the UE by the network entity when sending the RRC connection request message.

The message 3 or the RRC connection request message includes UE identity, for example, a temporary mobile subscriber identity (TMSI) or a random value. The TMSI is used for identifying the UE in a core network and if the UE has previously connected to the same core network. The random value is also used if the UE is connecting to the network entity for a first time. The message 3 may include a connection establishment cause, which indicates the reason the UE needs to connect to the network entity.

The UE receives a message 4 (e.g., MSG4) from the network entity (e.g., over a PDSCH). The message 4 is a contention resolution message from the network entity if the network entity successfully received and/or decoded the message 3 sent from the UE. The network entity transmits the message 4 to the network entity using the TMSI value of the random number described above, but may also contain a new C-RNTI which will be used for further communications between the UE and the network entity. The UE uses the above described four-step RACH procedure for synchronizing with the network entity when establishing a connection.

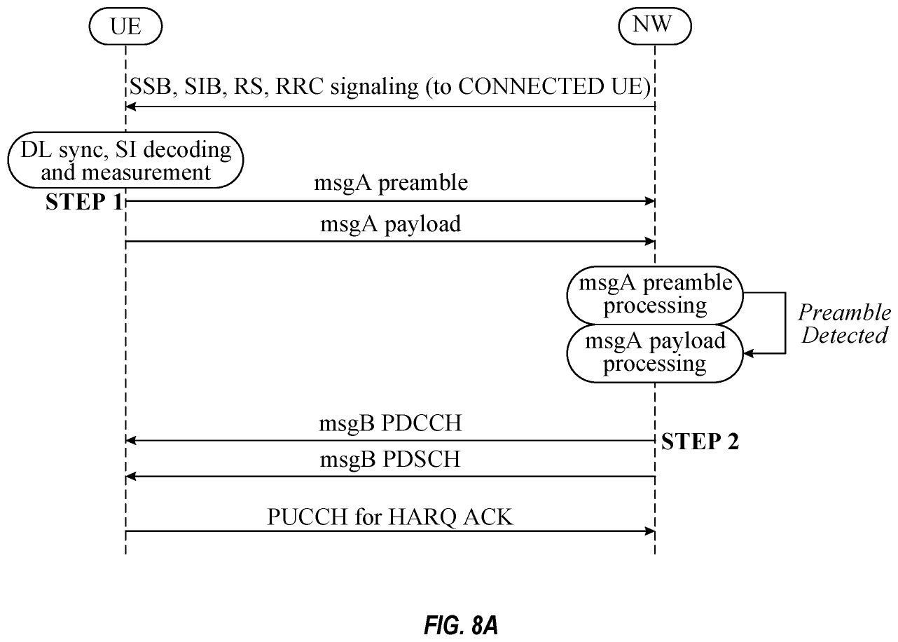

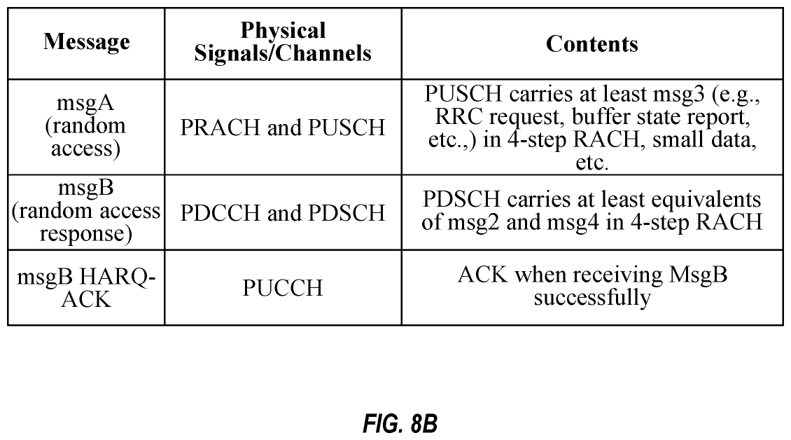

FIGS. 8A and 8B illustrate an example two-step RACH procedure at a UE. After downlink synchronization (e.g., via SSB), the UE performs the two-step RACH procedure for uplink synchronization.

At step 1, the UE transmits a message A (e.g., msgA), also referred to a first message of the two-step RACH procedure, to a network entity. In an aspect, for example, message 1 and message 3 described above in reference to FIG. 7A above, may be collapsed (e.g., combined) into the first message and sent to the network entity. The message 1 may include a sequence, which may have been selected from possible sequences, and may be used a reference signal (RS) for demodulation of data transmitted in the first message.

At step 2, the UE receives a message B (e.g., msgB), also referred to a second message of the two-step RACH procedure, from the network entity. The UE receives the second message, in response to sending the first message to the network entity. The message B may be a combination of message 2 and message 4 as described above in reference to FIG. 7A. The UE may send a hybrid automatic repeat request (HARD) acknowledgment (ACK) to the network entity on successfully receiving the message B.

The combining of messages 1 and 3 into one message A and receiving of message B in response from the network entity allows the UE to reduce the RACH procedure setup time to support low-latency requirements of 5G/NR. Although, the UE may be configured to support the two-step RACH procedure, the UE still supports the four-step RACH procedure as a fall back as the UE may not be able to relay on the two-step RACH procedure due to some constraints, e.g., high transmit power requirements, etc. So, the UE in 5G/NR may be configured to support both the two-step and the four-step RACH procedures, and determines which RACH procedure to configure based on the RACH configuration information received from the network entity. Some of use cases of the two-step RACH procedure may include transition from RRC IDLE/INACTIVE state to RRC CONNECTED state, small data transmission in RRC IDLE/INACTIVE state, handover from source cell to target cell in RRC CONNECTED, and/or in RRC CONNECTED (i.e., UE recovers uplink synchronization loss).

The above-noted RACH procedures may be performed using one of multiple waveforms (e.g., a discrete fourier transform-spread-orthogonal frequency division multiplexing (DFT-S-OFDM) waveform, a cyclic prefix orthogonal frequency division multiplexing (CP-OFDM) waveform, and/or other waveforms). The CP-OFDM waveforms may be used for a single-stream transmission and/or multi-stream (e.g., multiple input multiple output (MIMO)) transmissions, while DFT-S-OFDM waveforms may be limited to single stream transmissions (e.g., link budget limited cases).

Some UEs may only support the CP-OFDM waveform, by default. Since the RACH procedure can be performed using different waveforms and some UEs only support the CP-OFDM waveform by default, there is a need for the UE to signal (e.g., via UE capability information) whether a single carrier (SC) waveform (e.g., DFT-S-OFDM waveform) is also supported by the UE.

### Aspects Related to Waveform Support Capability Signaling During Initial Access

Aspects of the present disclosure provide mechanisms for signaling a user equipment (UE) capability to support multiple waveforms. For example, in some cases, a UE may indicate: (i) support for a single carrier (SC) waveform in a downlink (i.e., whether a user equipment (UE) has a transceiver for a discrete fourier transform-spread-orthogonal frequency division multiplexing (DFT-S-OFDM) waveform during an initial access procedure), (ii) a switching time between two waveforms (e.g., the DFT-S-OFDM waveform and a cyclic prefix orthogonal frequency division multiplexing (CP-OFDM) waveform) during the initial access procedure, and/or (iii) a preference in using a certain waveform (e.g., the DFT-S-OFDM waveform or the CP-OFDM waveform) during the initial access procedure.

In some cases, signaling the UE capability to support different waveforms may result in a higher data rate and spectral efficiency. For example, in some scenarios that may require a high energy efficiency, the UE capability may indicate support and preference of the DFT-S-OFDM waveform (e.g., suitable for a power efficient transmission and having a low peak-to-average-power ratio (PAPR)) over the CP-OFDM waveform. The lower PAPR of the DFT-S-OFDM waveform translates to a higher power added (PA) efficiency and data rate.

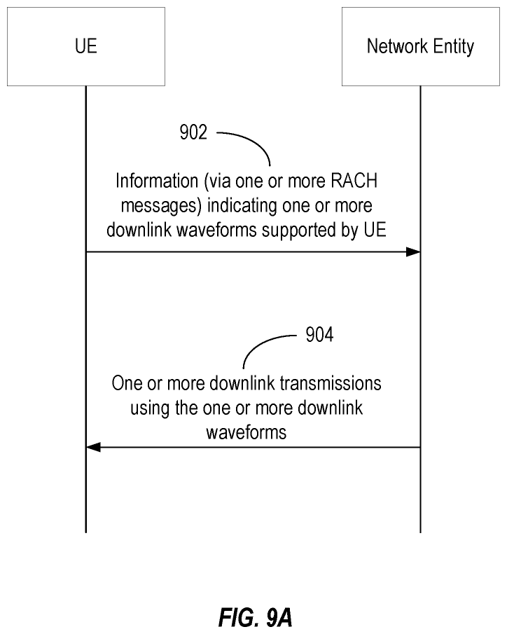

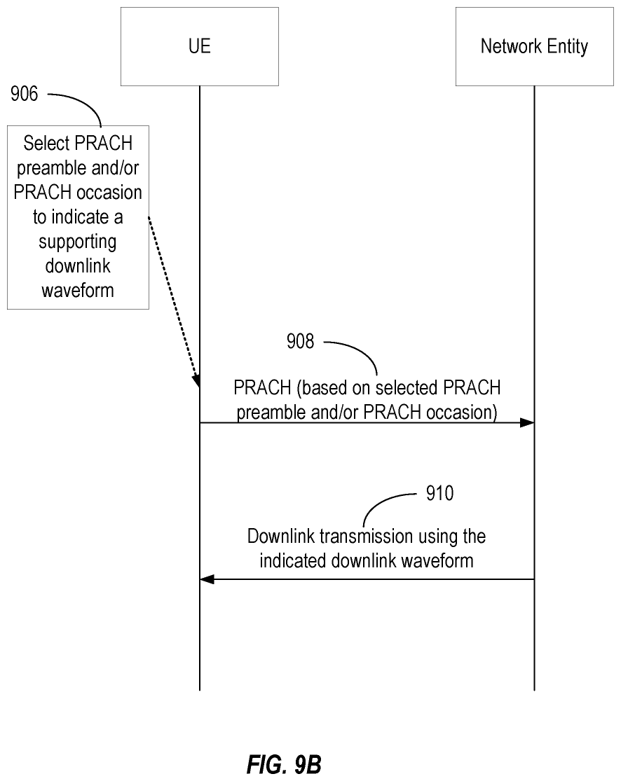

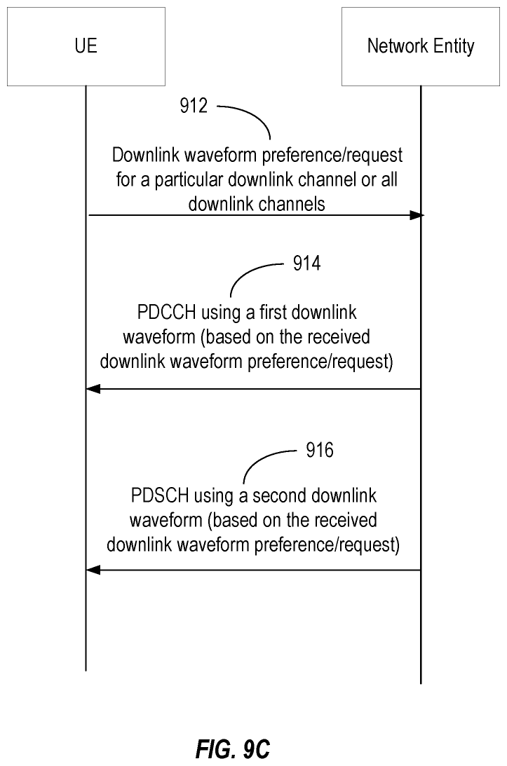

FIGS. 9A-9C depict process flows for communications in a network between a network entity and a UE. In some aspects, the network entity may be an example of the BS 102 depicted and described with respect to FIGS. 1 and 3 or a disaggregated BS depicted and described with respect to FIG. 2. Similarly, the UE may be an example of the UE 104 depicted and described with respect to FIGS. 1 and 3. However, in other aspects, the UE 104 may be another type of wireless communications device and the BS 102 may be another type of network entity or network node, such as those described herein.

As illustrated in FIG. 9A, at 902, the UE transmits to the network entity, via one or more random access channel (RACH) messages, information indicating one or more downlink waveforms supported by the UE. The one or more downlink waveforms may include a SC waveform (e.g., a DFT-S-OFDM waveform) and/or a CP-OFDM waveform. The information may also indicate a switching time gap between different downlink waveforms supported by the UE.

At 904, the network entity transmits one or more downlink transmissions to the UE using the one or more downlink waveforms supported by the UE.

In some aspects, the UE transmits the information to the network entity via a physical RACH (PRACH) message (e.g., MSG 1) of a four-step RACH procedure. For example, as illustrated in FIG. 9B, at 906, the UE initially selects a PRACH preamble and/or a PRACH occasion to indicate a supporting downlink waveform. At 908, the UE transmits the PRACH message to the network entity (e.g., based on the selected PRACH preamble and/or a PRACH occasion) to indicate the supporting downlink waveform. At 910, the network entity transmits a downlink transmission to the UE (e.g., using the indicated downlink waveform supported by the UE).

In one example, the UE selects the PRACH preamble (e.g., for the PRACH message) from different sets of PRACH preambles/sequences. The different sets of PRACH preambles may include a first PRACH preamble indicating a particular downlink waveform (e.g., CP-OFDM waveform or SC waveform) within the one or more downlink waveforms is supported by the UE. The different sets of PRACH preambles may also include a second PRACH preamble indicating all downlink waveforms (e.g., both CP-OFDM waveform and SC waveform) are supported by the UE.

In another example, the UE selects the PRACH occasion (e.g., for the PRACH message) from different sets of PRACH occasions. The different sets of PRACH occasions may include a first PRACH occasion indicating a particular downlink waveform (e.g., SC waveform) within the one or more downlink waveforms is supported by the UE. The different sets of PRACH occasions may also include a second PRACH occasion indicating all downlink waveforms (e.g., both CP-OFDM waveform and SC waveform) are supported by the UE.

In some cases, the PRACH message includes one or more PRACH preambles, and a PRACH preamble per PRACH occasion is associated with a mask. For example, eight PRACH occasions may be associated with a synchronization signal block (SSB). A PRACH mask index may be indicated (e.g., by ra-ssb-OccasionMaskIndex). The PRACH mask index indicates the PRACH occasions for a PRACH transmission where the PRACH occasions are associated with a selected synchronization signal (SS)/physical broadcast channel (PBCH) block index. In some cases, two mask indices (e.g., a first mask indice (e.g., ra-ssb-OccasionMaskIndex_for CP-OFDM waveform and SC waveform support) and a second mask indice (e.g., ra-ssb-OccasionMaskIndex_for CP-OFDM waveform support)) may be defined such that one set is for the UE supporting the SC waveform in downlink and the other if the UE does not support SC waveform in the downlink. The network entity may transmit the first mask indice and all other masks to the UE in the SSB (e.g., as part of master information block (MIB)) or as part of system information block (SIB) 1. In some cases, the masks can be complementary or orthogonal to uniquely identify waveform(s) capability.

In some aspects, the UE transmits the information to the network entity via a scheduled uplink transmission message (e.g., MSG3) of the four-step RACH procedure (instead of MSG1). This will enable downlink waveform configuration for MSG4 and beyond. In such cases, a switching time gap between two (or more) downlink waveforms (from a first downlink waveform to a second downlink waveform) is signaled in MSG3 payload.

In some aspects, the UE transmits the information to the network entity via a first message (e.g., msgA physical uplink shared channel (PUSCH)) of a two-step RACH procedure. For example, the information is transmitted in a payload or a PUSCH demodulation reference signal (DMRS) configuration message (e.g., using different DMRS sequences/configurations/ports for different types of downlink waveforms supported by the UE).

As illustrated in FIG. 9C, at 912, the UE transmits a downlink waveform recommendation/preference/request for a particular downlink channel or all downlink channels (or supported downlink waveforms for each frequency band and band combination) to the network entity. The UE may signal the downlink waveform request in MSG3 payload (e.g, in case of four-step RACH procedure) or msgA payload (e.g., in case of two-step RACH procedure).

In one example, the downlink waveform request may indicate to use a SC waveform for a downlink grant (DG) physical downlink shared channel (PDSCH) transmission. In another example, the downlink waveform request may indicate to use a CP-OFDM waveform for a semi-persistent scheduling (SPS) PDSCH transmission. In another example, the downlink waveform request may indicate to use a first downlink waveform for a physical downlink control channel (PDCCH) transmission and a second downlink waveform for a PDSCH transmission. In another example, the downlink waveform request may indicate to use a first downlink waveform, a second downlink waveform, and/or a third downlink waveform for a first frequency band. In another example, the downlink waveform request may indicate to use a first downlink waveform and a second downlink waveform for a second frequency band.

At 914, the network entity transmits the PDCCH transmission using the first downlink waveform, based on the received downlink waveform request.

At 916, the network entity transmits the PDSCH transmission using the second downlink waveform, based on the received downlink waveform request.

In some cases, different downlink waveform requests may be triggered based on different conditions. For example, the downlink waveform requests may be triggered based on downlink reference signal received power (RSRP), which may indicate a geometry/location of the UE. In one example, the downlink waveform request may indicate the CP-OFDM waveform for a cell-center UE while the SC waveform for a cell-edge UE.

### Example Operations of a User Equipment

FIG. 10 shows a method 1000 for wireless communications by a UE, such as UE 104 of FIGS. 1 and 3. The method 1000 may be implemented as software components that are executed and run on one or more processors (e.g., controller/processor 380 of FIG. 3). Further, transmission and reception of signals by the UE in the method 1000 may be enabled, for example, by one or more antennas (e.g., antennas 352 of FIG. 3). In certain aspects, the transmission and/or reception of signals by the UE may be implemented via a bus interface of one or more processors (e.g., the controller/processor 380) obtaining and/or outputting signals.

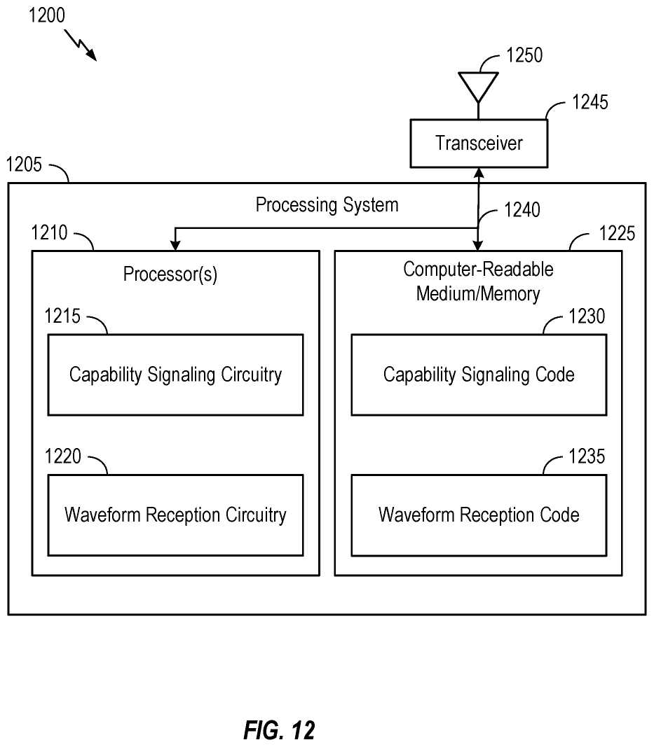

Method 1000 begins at 1005 with transmitting, to a network entity, via one or more RACH messages, information indicating one or more downlink waveforms supported by the UE. In some cases, the operations of this step refer to, or may be performed by, capability signaling circuitry and/or capability signaling code as described with reference to FIG. 12.

Method 1000 then proceeds to step 1010 with receiving, from the network entity, one or more downlink transmissions using the one or more downlink waveforms supported by the UE. In some cases, the operations of this step refer to, or may be performed by, waveform reception circuitry and/or waveform reception code as described with reference to FIG. 12.

In some aspects, the information further indicates a switching time gap between different downlink waveforms supported by the UE.

In some aspects, the one or more downlink waveforms comprise a SC waveform.

In some aspects, the one or more downlink waveforms comprise a CP-OFDM waveform.

In some aspects, the transmitting comprises transmitting the information via a PRACH message of a four-step RACH procedure.

In some aspects, the PRACH message comprises a PRACH preamble selected from different sets of PRACH preambles, wherein the different sets of PRACH preambles comprise a first PRACH preamble indicating a particular downlink waveform within the one or more downlink waveforms is supported by the UE and a second PRACH preamble indicating all downlink waveforms within the one or more downlink waveforms are supported by the UE.

In some aspects, the PRACH message is transmitted in a PRACH occasion selected from different sets of PRACH occasions, wherein the different sets of PRACH occasions comprise a first PRACH occasion indicating a particular downlink waveform within the one or more downlink waveforms is supported by the UE and a second PRACH occasion indicating all downlink waveforms within the one or more downlink waveforms are supported by the UE.

In some aspects, the PRACH message comprises one or more PRACH preambles, and wherein a PRACH preamble per PRACH occasion is associated with a mask.

In some aspects, the transmitting comprises transmitting the information via a scheduled uplink transmission message of a four-step RACH procedure.

In some aspects, the transmitting comprises transmitting the information via a first message of a two-step RACH procedure.

In some aspects, the first message corresponds to a PUSCH DMRS configuration message, and wherein the information is indicated using different DMRS sequences for different types of downlink waveforms supported by the UE.

In some aspects, the information further indicates a preference of the UE in using a certain downlink waveform of the one or more downlink waveforms.

In some aspects, the preference indicates a downlink waveform request for a particular downlink channel or all downlink channels.

In some aspects, the preference indicates the one or more downlink waveforms supported by the UE for each frequency band.

In some aspects, the preference indicates the one or more downlink waveforms supported by the UE for a combination of frequency bands.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Operations of a Network Entity

FIG. 11 shows a method 1100 for wireless communications by a network entity, such as BS 102 of FIGS. 1 and 3, or a disaggregated BS as discussed with respect to FIG. 2. The method 1100 may be implemented as software components that are executed and run on one or more processors (e.g., controller/processor 340 of FIG. 3). Further, transmission and reception of signals by the network entity in the method 1100 may be enabled, for example, by one or more antennas (e.g., antennas 334 of FIG. 3). In certain aspects, the transmission and/or reception of signals by the network entity may be implemented via a bus interface of one or more processors (e.g., the controller/processor 340) obtaining and/or outputting signals.

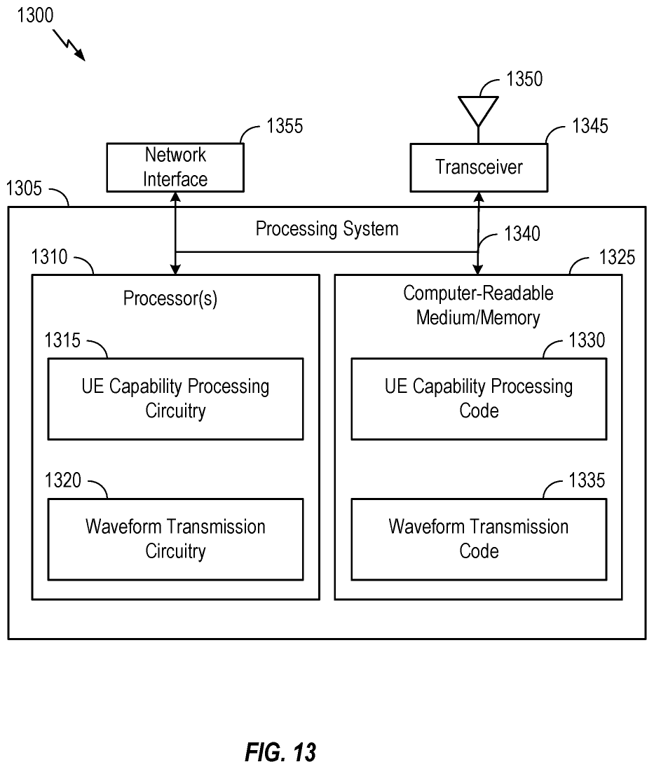

Method 1100 begins at 1105 with receiving, from a UE, via one or more RACH messages, information indicating one or more downlink waveforms supported by the UE. In some cases, the operations of this step refer to, or may be performed by, UE capability processing circuitry and/or UE capability processing code as described with reference to FIG. 13.

Method 1100 then proceeds to step 1110 with transmitting, to the UE, one or more downlink transmissions using the one or more downlink waveforms supported by the UE. In some cases, the operations of this step refer to, or may be performed by, waveform transmission circuitry and/or waveform transmission code as described with reference to FIG. 13.

In some aspects, the information further indicates a switching time gap between different downlink waveforms supported by the UE.

In some aspects, the one or more downlink waveforms comprise a SC waveform.

In some aspects, the one or more downlink waveforms comprise a CP-OFDM waveform.

In some aspects, the receiving comprises receiving the information via a PRACH message of a four-step RACH procedure.

In some aspects, the PRACH message comprises a PRACH preamble selected from different sets of PRACH preambles, wherein the different sets of PRACH preambles comprise a first PRACH preamble indicating a particular downlink waveform within the one or more downlink waveforms is supported by the UE and a second PRACH preamble indicating all downlink waveforms within the one or more downlink waveforms are supported by the UE.

In some aspects, the PRACH message is received in a PRACH occasion selected from different sets of PRACH occasions, wherein the different sets of PRACH occasions comprise a first PRACH occasion indicating a particular downlink waveform within the one or more downlink waveforms is supported by the UE and a second PRACH occasion indicating all downlink waveforms within the one or more downlink waveforms are supported by the UE.

In some aspects, the receiving comprises receiving the information via a scheduled uplink transmission message of a four-step RACH procedure.

In some aspects, the receiving comprises receiving the information via a first message of a two-step RACH procedure, and wherein the first message corresponds to a PUSCH DMRS configuration message, and wherein the information is indicated using different DMRS sequences for different types of downlink waveforms supported by the UE.

In some aspects, the information further indicates a preference of the UE in using a certain downlink waveform of the one or more downlink waveforms.

In some aspects, the preference indicates one or more of: a downlink waveform request for a particular downlink channel or all downlink channels, the one or more downlink waveforms supported by the UE for each frequency band, or the one or more downlink waveforms supported by the UE for a combination of frequency bands.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to the transceiver 1245 (e.g., a transmitter and/or a receiver). The transceiver 1245 is configured to transmit and receive signals for the communications device 1200 via the antenna 1250, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1225 via a bus 1240. In certain aspects, the computer-readable medium/memory 1225 is configured to store instructions (e.g., computer-executable code) that when executed by the one or more processors 1210, cause the one or more processors 1210 to perform the method 1000 described with respect to FIG. 10, or any aspect related to it. Note that reference to a processor performing a function of communications device 1200 may include one or more processors 1210 performing that function of communications device 1200.

In the depicted example, computer-readable medium/memory 1225 stores code (e.g., executable instructions), such as capability signaling code 1230 and waveform reception code 1235. Processing of the capability signaling code 1230 and waveform reception code 1235 may cause the communications device 1200 to perform the method 1000 described with respect to FIG. 10, or any aspect related to it.

The one or more processors 1210 include circuitry configured to implement (e.g., execute) the code stored in the computer-readable medium/memory 1225, including circuitry such as capability signaling circuitry 1215 and waveform reception circuitry 1220. Processing with capability signaling circuitry 1215 and waveform reception circuitry 1220 may cause the communications device 1200 to perform the method 1000 described with respect to FIG. 10, or any aspect related to it.

Various components of the communications device 1200 may provide means for performing the method 1000 described with respect to FIG. 10, or any aspect related to it. For example, means for transmitting, sending or outputting for transmission may include transceivers 354 and/or antenna(s) 352 of the UE 104 illustrated in FIG. 3 and/or the transceiver 1245 and the antenna 1250 of the communications device 1200 in FIG. 12. Means for receiving or obtaining may include transceivers 354 and/or antenna(s) 352 of the UE 104 illustrated in FIG. 3 and/or the transceiver 1245 and the antenna 1250 of the communications device 1200 in FIG. 12.

FIG. 13 depicts aspects of an example communications device 1300. In some aspects, communications device 1300 is a network entity, such as BS 102 of FIGS. 1 and 3, or a disaggregated BS as discussed with respect to FIG. 2.

The communications device 1300 includes a processing system 1305 coupled to the transceiver 1345 (e.g., a transmitter and/or a receiver) and/or a network interface 1355. The transceiver 1345 is configured to transmit and receive signals for the communications device 1300 via the antenna 1350, such as the various signals as described herein. The network interface 1355 is configured to obtain and send signals for the communications device 1300 via communication link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1325 via a bus 1340. In certain aspects, the computer-readable medium/memory 1325 is configured to store instructions (e.g., computer-executable code) that when executed by the one or more processors 1310, cause the one or more processors 1310 to perform the method 1100 described with respect to FIG. 11, or any aspect related to it. Note that reference to a processor of communications device 1300 performing a function may include one or more processors 1310 of communications device 1300 performing that function.

In the depicted example, the computer-readable medium/memory 1325 stores code (e.g., executable instructions), such as UE capability processing code 1330 and waveform transmission code 1335. Processing of the UE capability processing code 1330 and waveform transmission code 1335 may cause the communications device 1300 to perform the method 1100 described with respect to FIG. 11, or any aspect related to it.

The one or more processors 1310 include circuitry configured to implement (e.g., execute) the code stored in the computer-readable medium/memory 1325, including circuitry such as UE capability processing circuitry 1315 and waveform transmission circuitry 1320. Processing with UE capability processing circuitry 1315 and waveform transmission circuitry 1320 may cause the communications device 1300 to perform the method 1100 as described with respect to FIG. 11, or any aspect related to it.

Various components of the communications device 1300 may provide means for performing the method 1100 as described with respect to FIG. 11, or any aspect related to it. Means for transmitting, sending or outputting for transmission may include transceivers 332 and/or antenna(s) 334 of the BS 102 illustrated in FIG. 3 and/or the transceiver 1345 and the antenna 1350 of the communications device 1300 in FIG. 13. Means for receiving or obtaining may include transceivers 332 and/or antenna(s) 334 of the BS 102 illustrated in FIG. 3 and/or the transceiver 1345 and the antenna 1350 of the communications device 1300 in FIG. 13.

### Example Clauses

Implementation examples are described in the following numbered clauses:

Clause 1: A method for wireless communications by a UE, comprising: transmitting, to a network entity, via one or more RACH messages, information indicating one or more downlink waveforms supported by the UE; and receiving, from the network entity, one or more downlink transmissions using the one or more downlink waveforms supported by the UE.

Clause 2: The method of Clause 1, wherein the information further indicates a switching time gap between different downlink waveforms supported by the UE.

Clause 3: The method of any one of Clauses 1 and 2, wherein the one or more downlink waveforms comprise a SC waveform.

Clause 4: The method of any one of Clauses 1-3, wherein the one or more downlink waveforms comprise a CP-OFDM waveform.

Clause 5: The method of any one of Clauses 1-4, wherein the transmitting comprises transmitting the information via a PRACH message of a four-step RACH procedure.

Clause 6: The method of Clause 5, wherein the PRACH message comprises a PRACH preamble selected from different sets of PRACH preambles, wherein the different sets of PRACH preambles comprise a first PRACH preamble indicating a particular downlink waveform within the one or more downlink waveforms is supported by the UE and a second PRACH preamble indicating all downlink waveforms within the one or more downlink waveforms are supported by the UE.

Clause 7: The method of Clause 5, wherein the PRACH message is transmitted in a PRACH occasion selected from different sets of PRACH occasions, wherein the different sets of PRACH occasions comprise a first PRACH occasion indicating a particular downlink waveform within the one or more downlink waveforms is supported by the UE and a second PRACH occasion indicating all downlink waveforms within the one or more downlink waveforms are supported by the UE.

Clause 8: The method of Clause 5, wherein the PRACH message comprises one or more PRACH preambles, and wherein a PRACH preamble per PRACH occasion is associated with a mask.

Clause 9: The method of any one of Clauses 1-8, wherein the transmitting comprises transmitting the information via a scheduled uplink transmission message of a four-step RACH procedure.

Clause 10: The method of any one of Clauses 1-9, wherein the transmitting comprises transmitting the information via a first message of a two-step RACH procedure.

Clause 11: The method of Clause 10, wherein the first message corresponds to a PUSCH DMRS configuration message, and wherein the information is indicated using different DMRS sequences for different types of downlink waveforms supported by the UE.

Clause 12: The method of any one of Clauses 1-11, wherein the information further indicates a preference of the UE in using a certain downlink waveform of the one or more downlink waveforms.

Clause 13: The method of Clause 12, wherein the preference indicates a downlink waveform request for a particular downlink channel or all downlink channels.

Clause 14: The method of Clause 12, wherein the preference indicates the one or more downlink waveforms supported by the UE for each frequency band.

Clause 15: The method of Clause 12, wherein the preference indicates the one or more downlink waveforms supported by the UE for a combination of frequency bands.

Clause 16: A method for wireless communications by a network entity, comprising: receiving, from a UE, via one or more RACH messages, information indicating one or more downlink waveforms supported by the UE; and transmitting, to the UE, one or more downlink transmissions using the one or more downlink waveforms supported by the UE.

Clause 17: The method of Clause 16, wherein the information further indicates a switching time gap between different downlink waveforms supported by the UE.

Clause 18: The method of any one of Clauses 16 and 17, wherein the one or more downlink waveforms comprise a SC waveform.

Clause 19: The method of any one of Clauses 16-18, wherein the one or more downlink waveforms comprise a CP-OFDM waveform.

Clause 20: The method of any one of Clauses 16-19, wherein the receiving comprises receiving the information via a PRACH message of a four-step RACH procedure.

Clause 21: The method of Clause 20, wherein the PRACH message comprises a PRACH preamble selected from different sets of PRACH preambles, wherein the different sets of PRACH preambles comprise a first PRACH preamble indicating a particular downlink waveform within the one or more downlink waveforms is supported by the UE and a second PRACH preamble indicating all downlink waveforms within the one or more downlink waveforms are supported by the UE.

Clause 22: The method of Clause 20, wherein the PRACH message is received in a PRACH occasion selected from different sets of PRACH occasions, wherein the different sets of PRACH occasions comprise a first PRACH occasion indicating a particular downlink waveform within the one or more downlink waveforms is supported by the UE and a second PRACH occasion indicating all downlink waveforms within the one or more downlink waveforms are supported by the UE.

Clause 23: The method of any one of Clauses 16-22, wherein the receiving comprises receiving the information via a scheduled uplink transmission message of a four-step RACH procedure.

Clause 24: The method of any one of Clauses 16-23, wherein the receiving comprises receiving the information via a first message of a two-step RACH procedure, and wherein the first message corresponds to a PUSCH DMRS configuration message, and wherein the information is indicated using different DMRS sequences for different types of downlink waveforms supported by the UE.

Clause 25: The method of any one of Clauses 16-24, wherein the information further indicates a preference of the UE in using a certain downlink waveform of the one or more downlink waveforms.

Clause 26: The method of Clause 25, wherein the preference indicates one or more of: a downlink waveform request for a particular downlink channel or all downlink channels, the one or more downlink waveforms supported by the UE for each frequency band, or the one or more downlink waveforms supported by the UE for a combination of frequency bands.

Clause 27: An apparatus, comprising: a memory comprising executable instructions; and a processor configured to execute the executable instructions and cause the apparatus to perform a method in accordance with any one of Clauses 1-26.

Clause 28: An apparatus, comprising means for performing a method in accordance with any one of Clauses 1-26.

Clause 29: A non-transitory computer-readable medium comprising executable instructions that, when executed by a processor of an apparatus, cause the apparatus to perform a method in accordance with any one of Clauses 1-26.

Clause 30: A computer program product embodied on a computer-readable storage medium comprising code for performing a method in accordance with any one of Clauses 1-26.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) configured for wireless communication, comprising: a memory comprising computer-executable instructions; and one or more processors configured to execute the computer-executable instructions and cause the UE to:
transmit, to a network entity, via one or more random access channel (RACH) messages, information indicating one or more downlink waveforms supported by the UE; and
receive, from the network entity, one or more downlink transmissions using the one or more downlink waveforms supported by the UE.

2. The UE of claim 1, wherein the information further indicates a switching time gap between different downlink waveforms supported by the UE.

3. The UE of claim 1, wherein the one or more downlink waveforms comprise a single carrier (SC) waveform.

4. The UE of claim 1, wherein the one or more downlink waveforms comprise a cyclic prefix orthogonal frequency-division multiplexing (CP-OFDM) waveform.

5. The UE of claim 1, wherein the transmit comprises transmit the information via a physical RACH (PRACH) message of a four-step RACH procedure.

6. The UE of claim 5, wherein the PRACH message comprises a PRACH preamble selected from different sets of PRACH preambles, wherein the different sets of PRACH preambles comprise a first PRACH preamble indicating a particular downlink waveform within the one or more downlink waveforms is supported by the UE and a second PRACH preamble indicating all downlink waveforms within the one or more downlink waveforms are supported by the UE.

7. The UE of claim 5, wherein the PRACH message is transmitted in a PRACH occasion selected from different sets of PRACH occasions, wherein the different sets of PRACH occasions comprise a first PRACH occasion indicating a particular downlink waveform within the one or more downlink waveforms is supported by the UE and a second PRACH occasion indicating all downlink waveforms within the one or more downlink waveforms are supported by the UE.

8. The UE of claim 5, wherein the PRACH message comprises one or more PRACH preambles, and wherein a PRACH preamble per PRACH occasion is associated with a mask.

9. The UE of claim 1, wherein the transmit comprises transmit the information via a scheduled uplink transmission message of a four-step RACH procedure.

10. The UE of claim 1, wherein the transmit comprises transmit the information via a first message of a two-step RACH procedure.

11. The UE of claim 10, wherein the first message corresponds to a physical uplink shared channel (PUSCH) demodulation reference signal (DMRS) configuration message, and wherein the information is indicated using different DMRS sequences for different types of downlink waveforms supported by the UE.

12. The UE of claim 1, wherein the information further indicates a preference of the UE in using a certain downlink waveform of the one or more downlink waveforms.

13. The UE of claim 12, wherein the preference indicates a downlink waveform request for a particular downlink channel or all downlink channels.

14. The UE of claim 12, wherein the preference indicates the one or more downlink waveforms supported by the UE for each frequency band.

15. The UE of claim 12, wherein the preference indicates the one or more downlink waveforms supported by the UE for a combination of frequency bands.

16. A network entity configured for wireless communication, comprising: a memory comprising computer-executable instructions; and one or more processors configured to execute the computer-executable instructions and cause the network entity to:
receive, from a user equipment (UE), via one or more random access channel (RACH) messages, information indicating one or more downlink waveforms supported by the UE; and
transmit, to the UE, one or more downlink transmissions using the one or more downlink waveforms supported by the UE.

17. The network entity of claim 16, wherein the information further indicates a switching time gap between different downlink waveforms supported by the UE.

18. The network entity of claim 16, wherein the one or more downlink waveforms comprise a single carrier (SC) waveform.

19. The network entity of claim 16, wherein the one or more downlink waveforms comprise a cyclic prefix orthogonal frequency-division multiplexing (CP-OFDM) waveform.

20. The network entity of claim 16, wherein the receive comprises receive the information via a physical RACH (PRACH) message of a four-step RACH procedure.

21. The network entity of claim 20, wherein the PRACH message comprises a PRACH preamble selected from different sets of PRACH preambles, wherein the different sets of PRACH preambles comprise a first PRACH preamble indicating a particular downlink waveform within the one or more downlink waveforms is supported by the UE and a second PRACH preamble indicating all downlink waveforms within the one or more downlink waveforms are supported by the UE.

22. The network entity of claim 20, wherein the PRACH message is received in a PRACH occasion selected from different sets of PRACH occasions, wherein the different sets of PRACH occasions comprise a first PRACH occasion indicating a particular downlink waveform within the one or more downlink waveforms is supported by the UE and a second PRACH occasion indicating all downlink waveforms within the one or more downlink waveforms are supported by the UE.

23. The network entity of claim 16, wherein the receive comprises receive the information via a scheduled uplink transmission message of a four-step RACH procedure.

24. The network entity of claim 16, wherein the receive comprises receive the information via a first message of a two-step RACH procedure, and wherein the first message corresponds to a physical uplink shared channel (PUSCH) demodulation reference signal (DMRS) configuration message, and wherein the information is indicated using different DMRS sequences for different types of downlink waveforms supported by the UE.

25. The network entity of claim 16, wherein the information further indicates a preference of the UE in using a certain downlink waveform of the one or more downlink waveforms.

26. The network entity of claim 25, wherein the preference indicates one or more of: a downlink waveform request for a particular downlink channel or all downlink channels, the one or more downlink waveforms supported by the UE for each frequency band, or the one or more downlink waveforms supported by the UE for a combination of frequency bands.

27. A method for wireless communications by a user equipment (UE), comprising:
transmitting, to a network entity, via one or more random access channel (RACH) messages, information indicating one or more downlink waveforms supported by the UE; and
receiving, from the network entity, one or more downlink transmissions using the one or more downlink waveforms supported by the UE.

28. The method of claim 27, wherein the information further indicates a switching time gap between different downlink waveforms supported by the UE.

29. A method for wireless communications by a network entity, comprising:
receiving, from a user equipment (UE), via one or more random access channel (RACH) messages, information indicating one or more downlink waveforms supported by the UE; and
transmitting, to the UE, one or more downlink transmissions using the one or more downlink waveforms supported by the UE.

30. The method of claim 29, wherein the information further indicates a switching time gap between different downlink waveforms supported by the UE.
